(19) United States
(12) Patent Application Publication
(10) Pub. No.: US 2016/0323420 A1
(43) Pub. Date: Nov. 3, 2016

(54) EXTERNAL LOAD FOR AN AIRCRAFT WITH UNIVERSAL CONTROL INTERFACE

(71) Applicant: AIRBUS DEFENCE AND SPACE GMBH, Ottobrunn (DE)

(72) Inventor: Joachim KUTKA, Neuburg (DE)

(73) Assignee: Airbus Defence and Space GmbH, Taufkirchen (DE)

(21) Appl. No.: 15/105,891

(22) PCT Filed: Dec. 6, 2014
(86) PCT No.: PCT/DE2014/000623

§ 371 Date: Jun. 17, 2016

(30) Foreign Application Priority Data
Dec. 19, 2013 (DE) 10 2013 021 689.3

(51) Int. Cl. H04L 29/06; B64D 9/00; H04L 29/08

(52) U.S. Cl. CPC H04L 69/08; H04L 67/12; B64D 9/00

(57) ABSTRACT

An external load for an aircraft includes a first control unit, designed to be coupled to the aircraft and to exchange control data therewith by a first specified input signal protocol and a first specified output signal protocol; a first payload space for accommodating a first payload; and a second control unit. The first payload is realized as a first function module for performing a function, the performance initiated by the aircraft by transferring control data to the first control unit. The second control unit is, arranged such that the control data according to the first specified output signal protocol serve as input signals for the second control unit. The second control unit is designed to convert the received input signals into a second output signal protocol in accordance with a first conversion protocol and to adapt said input signals to a control protocol of the first function module.

### CROSS-REFERENCE TO RELATED APPLICATIONS

The present application is a national phase entry under 35 U.S.C. § 371 of International Application No. PCT/DE2014/000623, filed Dec. 6, 2014, published in German, which claims priority from German Patent Application No. 10 2013 021 689.3 filed Dec. 19, 2013, the entire disclosures of which are hereby incorporated herein by reference.

### FIELD OF THE INVENTION

The present invention relates to an external load for an aircraft and an aircraft with such an external load. The external load is designed to accommodate at least one payload in the form of a function module.

### BACKGROUND OF THE INVENTION

Aircraft can comprise external loads, which can be designed to perform specific functions. For example, an external load can be a fuel tank or a sensor, for example an image sensor.

The external loads or the function modules accommodated in an external load of an aircraft are controlled by control elements, which are arranged in the aircraft. The function modules can also provide a response, feedback or upload to the aircraft, e.g., image signals or status signals, which are shown or displayed on a display unit in the aircraft. In an exemplary case, the display unit can be a display for showing dynamic contents, or a signal lamp for showing two states based on the operating status of the signal lamp (on/off).

Depending on the functions of a function module, it may here be necessary to adjust or adapt the control elements or display units in the aircraft to the functions and responses that are provided or transmitted back by a function module.

Such an adjustment or adaptation can adversely affect the control elements and potentially the display unit and require adjustments on the one hand, and may necessitate a different type of signal transmission or control data transmission on the other hand.

In the case of changes to an aircraft, it may be necessary to check the operation of the aircraft function modules influenced by the changes and aircraft function modules interacting therewith or even the entire aircraft, which may involve a rather significant effort and rather significant costs.

### BRIEF SUMMARY OF THE INVENTION

There may be a need for providing an external load for an aircraft that reduces the effort for adjusting the aircraft to a modified functional scope of the external load.

According to a first aspect, an external load for an aircraft is provided. The external load comprises a first control unit and a first payload space for accommodating a first payload. The first control unit is designed to be coupled with the aircraft and exchange control data with the aircraft by means of a first predetermined input signal protocol. The first payload is designed as a first function module for performing a function. The performing of the function is initiated by transmitting control data by or from the aircraft to the first control unit. The first control unit is designed to output control data according to a first predetermined output signal protocol. The external load is characterized by the fact that it comprises a second control unit, wherein the second control unit is arranged or adapted in such a way that the control data according to the first predetermined output signal protocol serve as input signals for the second control unit. The second control unit is further designed to convert the input signals it received into a second output signal protocol according to a first conversion protocol, and adjust or adapt them to a control protocol of the first function module.

In other words, this means that the first control unit is adjusted or customized to a data output interface of the aircraft, and the second control unit to a data input interface of the first external load, i.e., the function module. The second control unit receives the control data from the first control unit, and converts them in such a way that the converted data are used as commands for the function module.

If a function module with adjusted or amended functions or with an adjusted or amended command set has been provided, it is enough to adjust or adapt the second control unit to the adjusted function module. Both the first control unit and the data output interface of the aircraft to the first control unit remain the same. Due to the adjusted function module, no changes have to be made to aircraft operation and the transmitted control data.

An existing control data set between the aircraft and first control unit is converted into the second control unit and is thereby ascribed another meaning. The syntax of the aircraft-side control data set is not changed, only its semantics, since a predetermined command on the data output interface of the aircraft leads to another action or function in the function module.

In terms of the invention, the term protocol must be understood to refer to the electronic specification of the transmitted data, the mode of signal coding for transferring data proceeding from a first element (e.g., a control element in the aircraft) to a second element (e.g., the first control unit), and the command set for actuating the second element (e.g., the first control unit) with a specific, predetermined number of commands. In particular, the transfer of control data between the first element or second element can be wire bound.

The first control unit can be a specific or given control unit of an existing external load, e.g., a payload with various sensors or actuators, wherein the given control unit is constantly used, and the aircraft constantly bidirectionally exchanges data with the external load as described above and below, i.e., sends data to the first control unit and receives data from the first control unit.

Changes in the function modules can be taken into account by adjusting the conversion protocol. The aircraft and interfaces arranged directly on the aircraft along with the protocols used herein are consistent and the same, making it possible to reduce an authorization outlay for the use of adjusted function modules, for example, since the changes only relate to the conversion protocol and the second control unit, but not directly to the aircraft.

The first predetermined input signal protocol is received by the first control unit at an aircraft-side or aircraft facing interface, and can be referred to as the primary input signal.

The first predetermined output signal protocol is output from the first control unit to an interface facing the second control unit or external load, and can be referred to as the primary output signal.

The second control unit receives the primary output signal at its interface on the aircraft side or facing the first control unit as a secondary input signal.

The second control unit outputs a secondary output signal at an interface facing the function modules.

The data flow was described above as proceeding from the aircraft to the function modules. However, the interfaces are designed to set up a feedback channel for data flow from the function modules to the aircraft, thereby correspondingly reversing the function of the interfaces with respect to data input and data output for this case.

In an embodiment, the second control unit is designed to accommodate a second conversion protocol.

This makes it possible to exchange data with two different function modules via the same first control unit with a constant first predetermined input signal protocol, which is converted by the first control unit into a first predetermined output signal protocol, and serves as a second input signal protocol for the second control unit. The second control unit converts the second input signal protocol into a second output signal protocol by means of the conversion protocol.

According to another embodiment, the external load comprises a configuration interface, which is coupled with the second control unit and designed to transmit a conversion protocol to the second control unit.

This makes it possible to dynamically adjust the operation of the second control unit to a new function module.

According to another embodiment, the external load comprises a second payload, which is designed as a second function module. The second control unit is here designed to actuate the first function module via the first conversion protocol, and the second function module via the second conversion protocol.

According to another embodiment, the second control unit is designed to carry out the first conversion protocol and second conversion protocol in a concurrent manner.

This means that the two conversion protocols are provided with a quasi-parallel design, so that the second control unit can actuate more than one function module.

According to another embodiment, the control protocol of the first function module consists of discrete signals.

These discrete signals can be transmitted between the second control unit and function module via a data bus with a plurality of data lines in parallel or over a single line serially.

According to another embodiment, data are transmitted by means of a feedback channel from the function module via the second control unit to the first control unit, and the first control unit is designed to transmit the data of the feedback channel to the aircraft.

A return signal from the function module to the aircraft transmitted via the second control unit and first control unit can comprise in particular analog signals.

According to another embodiment, the external load comprises a casing or a housing, and the first control unit and second control unit are arranged inside the casing.

The casing can be coupled with the aircraft by means of a predetermined mechanical interface. Because the first control unit is independent of function module actuation, the data output interface between the aircraft and external load remains constant. If something about the function module changes or a new function module is provided, only the second control unit has to be adjusted by transmitting a conversion protocol adapted to the new function module to the second control unit.

According to another aspect, an aircraft with an external load as described above and below is provided.

According to an embodiment, the aircraft is designed to exchange control data with the first control unit, so that the first function module performs a function module-specific action.

In other words, the aircraft exchanges data in a defined way with the first control unit, independently of the function module and its operation and function. The first control unit relays a command to the second control unit, and, proceeding from this command of the first control unit, the second control unit provides a function module-specific command based on the conversion protocol and depending on the functional scope of the function module, so as to initiate or perform a desired function.

It should be noted that the above statements of course also apply to more than two function modules and more than two conversion protocols. The number of function modules is spatially only limited by the available useful space in the casing of the external load, and functionally only limited by the number of commands of the first predetermined input signal protocol or first predetermined output signal protocol of the first control unit.

In particular, the casing of the external load can be derived from a fuel tank, the interior of which is equipped with the corresponding payloads or function modules, and potentially divided into spatially separated payload spaces.

The first control unit can be a constituent of a target illuminating simulator, for example which simulates the functions of acquiring a target via optical sensors, tracking the latter, and illuminating it with the laser. Such a control unit is designed in such a way as to receive data for target acquisition and report the target position back to the aircraft. In this case, the aircraft will recognize the external load as a target illuminating device and actuate it as such. However, the second control unit will correspondingly convert the transmitted commands, so that any other function module is actuated.

For example, the function modules can be sensors, cameras, radio signal receivers, radio signal transmitters, control systems for unmanned flying objects, RADAR systems, or a measuring system. The control data can be transmitted from the aircraft to the external load via a bus system. As a consequence, various different function modules can be operated without any modifications to the aircraft.

In the case of dismantled function modules, the external load can be fitted with placeholder weights, so as to ensure a constant center of gravity and constant weight of the external load.

The external load can be used with any kind of aircraft desired, as long as the first control unit and casing of the external load along with the mechanical coupling elements of the external load are adjusted or matched to the aircraft.

### BRIEF DESCRIPTION OF THE DRAWINGS

Exemplary embodiments will be described in greater detail below based on the attached drawings. Shown on:

FIG. 1 is a schematic view of an external load according to an exemplary embodiment.

FIG. 2 is a schematic view of an aircraft with an external load according to another exemplary embodiment.

FIG. 3 is a schematic view of the structure of an aircraft with an external load according to another exemplary embodiment.

### DETAILED DESCRIPTION OF EXEMPLARY EMBODIMENTS

The following detailed description is merely exemplary in nature and is not intended to limit the invention or the application and uses of the invention. Furthermore, there is no intention to be bound by any theory presented in the preceding background or the following detailed description.

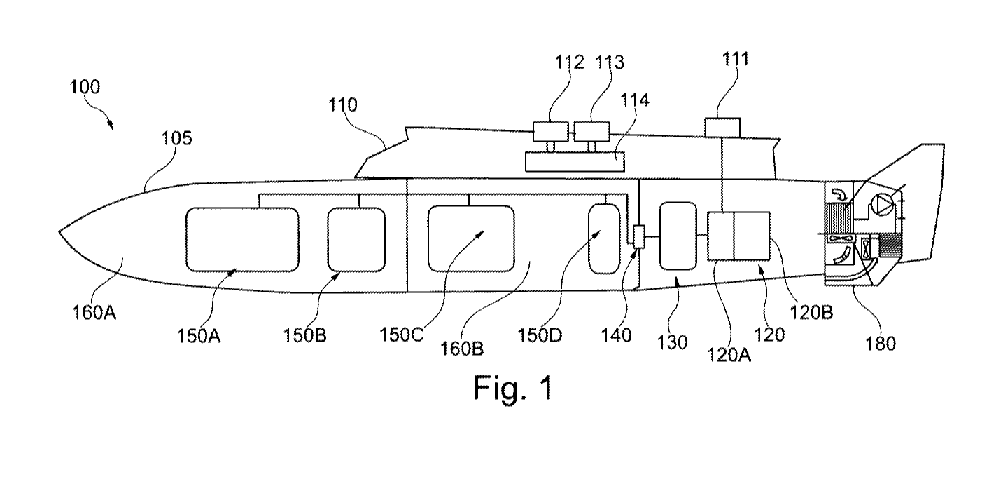

FIG. 1 shows an external load 100 with a casing 105. The casing comprises a mechanical coupling element 110, which is used to mechanically couple the external load 100 with an aircraft. Three signal interfaces 111, 112, 113 are arranged on the mechanical coupling element 110.

Data is exchanged between the aircraft 200 and external load 100 via the signal interface 111, for example according to transmission protocol MIL-STD 1760. This signal interface 111 is the primary external load interface, and connected with the first control unit 120. The first control unit 120 is connected with the second control unit 130. A conversion protocol is transmitted to the second control unit 130 via the signal interface 111 and the first control unit 120. The signal interfaces 112, 113 serve as redundant interfaces for transmitting external load information and control commands between the aircraft 200 and an external load release unit 114, which is designed as a mechanically detachable coupling element.

The external load release unit 114 can also be designed to dispense or simulate a specific external load relative to the aircraft, for example as a laser target illuminator, so that the aircraft actuates the external load via the interface 111 as if the external load actually involved the simulated external load. This makes it possible to ensure that the protocol transmitted via the signal interface 111 corresponds to the control protocol of the simulated external load independently of the actual external load, so that a corresponding conversion can take place via the second control unit 130.

The first control unit 120 can be functionally divided or separated into an image data unit 120A and a control element 120B. In particular, the image data unit 120A can prepare video signals in such a way that the return messages of the function units are processed into a video signal to be shown on a display unit in the aircraft. The control element 120B can convert the commands according to the first predetermined input signal protocol received from the control elements of the aircraft into commands according to the first predetermined output signal protocol. In particular, the control element 120B can be designed to receive control commands according to the transmission protocol Mil-STD 1553.

The first control unit 120 is coupled with the second control unit 130, so that the data of the first predetermined output signal protocol serve as input signals for the second control unit 130. The latter are then converted by the second control unit 130 and relayed to a function module 150A, 150B, 150C, 150D via the control interface 140.

The second control unit 130 is coupled to the first control unit 120 in particular without any reaction or retroactive effect. This means that the operation of the first control unit 120 and its interaction with the signal interface 111 is not influenced by the presence of the second control unit 130. The data of the fist predetermined output signal protocol are not changed for the input signals for the second control unit 130.

The function modules 150A, 150B, 150C, 150D are arranged in a first payload space 160A and a second payload space 160B.

The casing 105 of the external load can incorporate a cooling unit 180, which is thermally coupled with the first control unit 120, the second control unit 130 and the payload spaces 160A, 160B, so that the cooling unit 180 can cool these elements when needed.

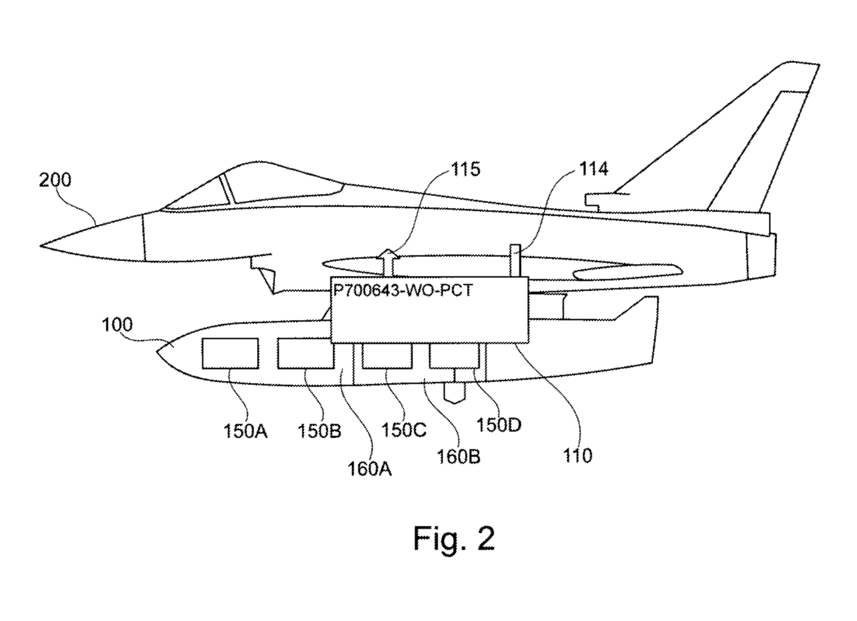

FIG. 2 shows an aircraft 200 with an external load 100, which is outwardly fastened in the underbody area of the aircraft.

The casing of the external load 100 can comprise several openings or recesses, which as an alternative to metal covers are sealed with a transparent material, for example plastic, so that sensors arranged in the casing can acquire data from the environment through the openings.

The aircraft 200 transmits control data 114 to the external load, and the external load transmits return data 115 to the aircraft.

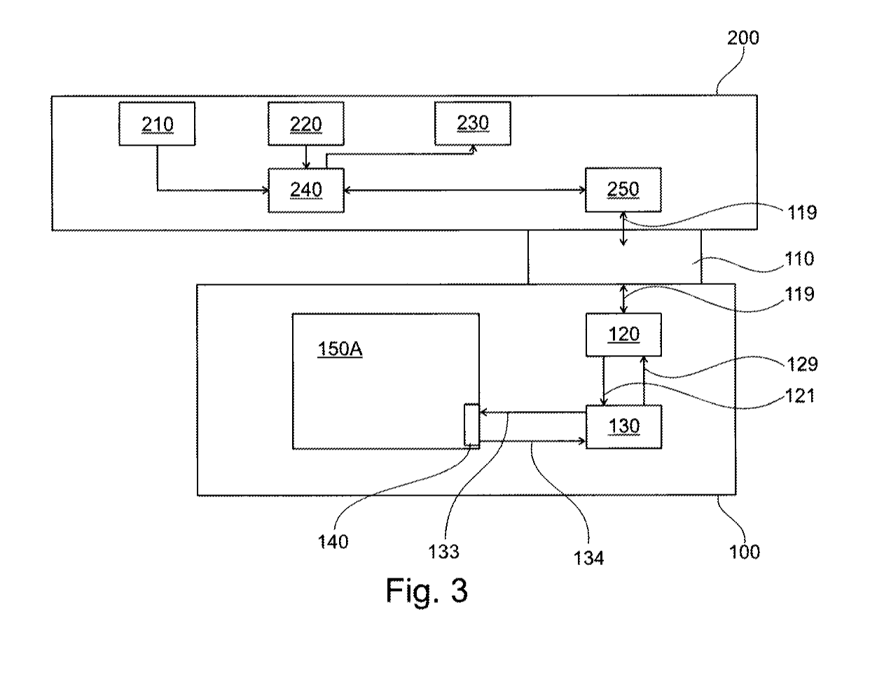

FIG. 3 shows the data flow between the external load 100 and an aircraft 200 as well as the functional coupling of the latter two.

Sensor information 210 from one or several sensors, various control inputs 220 of input instruments such as switches, joysticks and power levers, along with a display unit 230 are arranged in the generic depiction of the aircraft, and coupled with a central processing unit 240. The central processing unit 240 generically represents the totality of computing units for avionics. The central processing unit 240 is coupled with an output interface 250 for external loads, which in turn transmits data to the first control unit 120 or receives data from the first control unit via the coupling element 110.

The data transmitted to the first control unit 120 are referred to as the first predetermined input signal protocol 119, and represent the aircraft-side or aircraft facing data link.

The first control unit 120 processes the data received according to the first predetermined input signal protocol 119, and provides data according to the first predetermined output signal protocol 121, which are present at the second control unit 130 as a second input signal protocol 121. The second control unit 130 converts the second input signal protocol 121 into a second output signal protocol 133, which is provided at a transfer interface 140 for linking the function module 150A.

In particular, the transfer interface 140 is a transfer interface for signals between the second control unit 130 and a function module. The transfer interface 140 can here be arranged both on a front surface of a payload or on a partition wall of the casing 105, as well as on a function module. The transfer interface 140 functionally couples the second control unit 130 with one or more function modules.

For example, control data 133 are transmitted as discrete signals to a function module 150A. For example, analog data from the function module 150A are transmitted via the transfer interface 140 to the control unit as return messages 134.

The signal connections between the function blocks 240, 250, 120, 130 and 150A are shown in the drawings as bidirectional connections, i.e., data are transferred in both directions.

If a new function module 150A is provided, the software of the second control unit 130 must be correspondingly adapted, so as to convert the constant second input signal protocol 121 into the corresponding second output signal protocol 133, or the return message 134 is converted into the signal 129 from the second control unit 130 to the first control unit 120. As a consequence, a change in the function module 150A or an overall change of the functional module 150A only affects the second control unit 130 along with its link to the function module 150A. The first control unit 120 as well as the output interface 250 of the aircraft remain unchanged.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. An external load for an aircraft, wherein the external load comprises:
a first control unit configured to be coupled with the aircraft and to exchange control data with the aircraft by a first predetermined input signal protocol;
a first payload space for accommodating a first payload; and
a second control unit,
wherein the first payload is configured as a first function module for performing a function, and wherein the performing of the function is initiated by transmitting control data by the aircraft to the first control unit;
wherein the first control unit is configured to output control data according to a first predetermined output signal protocol;
wherein the second control unit is arranged in such a way that the control data according to the first predetermined output signal protocol serve as input signals for the second control unit; and
wherein the second control unit is configured to convert the input signals received by the second control unit into a second output signal protocol according to a first conversion protocol, and adjust them to a control protocol of the first function module.

2. The external load according to claim 1, wherein the second control unit is configured to accommodate a second conversion protocol.

3. The external load according to claim 1, comprising a configuration interface;
wherein the configuration interface is coupled with the second control unit and configured to transmit a conversion protocol to the second control unit.

4. The external load according to claim 2, further comprising a second payload configured as a second function module;
wherein the second control unit is configured to actuate the first function module via the first conversion protocol, and to actuate the second function module via the second conversion protocol.

5. The external load according to claim 2, wherein the second control unit is configured to carry out the first conversion protocol and second conversion protocol concurrently.

6. The external load according to claim 1, wherein the control protocol of the first function module includes discrete signals.

7. The external load according to claim 1, wherein data are transmitted by a feedback channel from the function module via the second control unit to the first control unit, and the first control unit is configured to transmit the data of the feedback channel to the aircraft.

8. The external load according to claim 1, further comprising a casing;
wherein the first control unit and the second control unit are arranged in the casing.

9. An aircraft, comprising an external load according wherein the external load comprises:
a first control unit configured to be coupled with the aircraft and to exchange control data with the aircraft by a first predetermined input signal protocol;
a first payload space for accommodating a first payload; and
a second control unit,
wherein the first payload is configured as a first function module for performing a function, and wherein the performing of the function is initiated by transmitting control data by the aircraft to the first control unit;
wherein the first control unit is configured to output control data according to a first predetermined output signal protocol;
wherein the second control unit is arranged in such a way that the control data according to the first predetermined output signal protocol serve as input signals for the second control unit; and
wherein the second control unit is configured to convert the input signals received by the second control unit into a second output signal protocol according to a first conversion protocol, and adjust them to a control protocol of the first function module.

10. The aircraft according to claim 9, wherein the aircraft is configured to exchange control data with the first control unit, so that the first function module performs a function module-specific action.
